(19) United States
(12) Patent Application Publication
(10) Pub. No.: US 2020/0120945 A1
(43) Pub. Date: Apr. 23, 2020

(54) CRYOGEN CONTROL FOR MIXING TEMPERATURE OF FOOD PRODUCTS

(71) Applicant: Messer Industries USA, Inc., Bridgewater, NJ (US)

(72) Inventors: Simon J. Shamoun, Acworth, GA (US); Robert Skobel, Rockwall, TX (US); Kenneth B. Cade, Rogers, AR (US); Claudio Valdez, Mansfield, TX (US)

(73) Assignee: Messer Industries USA, Inc., Bridgewater, NJ (US)

(21) Appl. No.: 16/601,639

(22) Filed: Oct. 15, 2019

Related U.S. Application Data
(60) Provisional application No. 62/747,727, filed on Oct. 19, 2018.

(51) Int. Cl. A23B 4/09

(52) U.S. Cl. CPC A23B 4/09

(57) ABSTRACT

A method for adjusting a viscosity of a food product for processing in a mixer includes measuring a weight and introductory temperature of a batch of the food product; determining a viscosity of the batch of the food product necessary for subsequent processing; determining a processing temperature of the batch necessary to arrive at the viscosity; and introducing an amount of cryogen into the batch based upon enthalpy of the batch for arriving at the processing temperature.

### BACKGROUND OF THE INVENTION

The present embodiments relate to determining and controlling an amount of cryogen to be provided to a food product in order to bring the product to a select temperature and viscosity for subsequent processing.

Many commercial and industrial refrigeration and freezing systems utilize liquid refrigerating or cooling agents. In many cases, the liquid refrigerating or cooling agents are liquid cryogens, such as liquid nitrogen, liquid oxygen, liquid argon, and refrigerants such as liquid carbon dioxide, etc. To date, there is no reliable way to meter an appropriate amount of such liquids to be applied to a food product for chilling of same while using only the minimum necessary to do so to bring the food product to a desired temperature for subsequent processing.

Because liquid cryogens are extremely cold, it is extremely difficult if not impossible to sufficiently insulate a conduit conveying the liquid cryogen to keep some of the liquid cryogen from evolving or changing phase into gas. Thus, a certain percentage of the volume flowing through the conduit consists of the gaseous form of the cryogen (resulting in two-phase flow), which makes it difficult to accurately meter, record and provide a desired flow of the cryogen for processing. Such inaccuracy results in unnecessary use of the cryogen liquid, thereby resulting in excessive costs of operation. Previously known methods of controlling liquid delivery include methods based upon volume or mass of liquid flowing through a conduit, time of injection, and temperature and viscosity of the products being cooled.

Methods of controlling liquid delivery based upon the volume or mass of liquid flowing through a conduit, such as those methods utilizing volumetric flow meters or Coriolis mass flow meters, are unable to accurately measure two-phase flow, may be extremely expensive, and the accuracy of the measurements obtained cannot be verified during operation. Further, turbine flow meters (a type of volumetric or mass flow meter) are only able to accurately measure single-phase flow.

Methods of controlling liquid delivery based upon time of injection of the cryogen into the utilizing process are vulnerable to the variability in flow rate introduced by the presence of the gaseous cryogen in the flow. The rate of cryogen injection may be highly variable, resulting in an uncertain (i.e., inaccurate) amount of cryogen being injected into the utilizing process.

Methods of controlling liquid delivery based upon the temperature of the product being cooled, such as a food product or a product from another type of process, have various vulnerabilities. That is, during the chilling process, the temperature probes utilized to measure the temperature of the product are difficult to keep clear of product or ice build-up and other effects such as product smearing or caking on the mixer walls; voids” or “pockets” in the product being cooled may also result in the probe reading the temperature of the cryogen or pocket atmosphere, rather than the temperature of the product; and hence accurate temperature readings may be difficult to obtain. Further, the amount of liquid utilized to cool the product cannot be accurately recorded without additional devices or apparatus, thereby resulting in increased cost and complexity of the system.

Methods of controlling liquid delivery based upon the viscosity of the products being cooled rely on sensing the mixer's or the blender's motor power, and require that the products undergo at least a partial phase change during the cooling process. Further, the amount of liquid utilized to cool the product cannot be accurately recorded without additional devices or apparatus, thereby resulting in increased cost and complexity of the system.

In previously known methods, a margin of error of up to about fifty percent (50%) in metering cryogenic liquids is possible. This is because the gaseous portion of the fluid may take up considerably more space in the conduit than the liquid portion of the fluid. At the normal operating pressure of many systems, there may be approximately a 50:1 gas to liquid volume ratio.

For example, if it is desired to provide 1,000 lbs. of liquid cryogen to a refrigeration system, as little as 500 lbs., and as much as 1,500 lbs., of liquid cryogen may be delivered to the refrigeration system. Because refrigeration/cooling processes typically require a specific amount of cooling power, it may become necessary to utilize a liquid cryogen which contains excess cooling power in order to compensate for receiving up to 50% less cryogenic liquid than what is desired or necessary for the process.

Food industry processors in particular, and to date, have had difficulty achieving a final desired temperature for the food product so that same can be immediately and subsequently processed into select shapes such as for example during forming operations. Such processing difficulties occur during mixing or blending of food products with liquid cryogens such as for example liquid nitrogen (LIN), carbon dioxide or liquid CO_{2,} the latter originating as a liquid in a storage tank for same and upon introduction into the mixer has converted into an approximate 50/50 mix of solid and gas. During such know processes, a food product is placed into a mixer, mixer-grinder, blender, tumbler or a kettle (collectively also referred to herein for the sake of brevity as a “mixer”). A liquid cryogen is injected into the mixer, such as by bottom injection, and the food product therein. “Bottom injection” refers to and is understood to mean in the food processing industry to inject a cryogen into a bottom region or volume of a mixing vessel. With solid products such as beef or poultry, the liquid cryogen is used to chill the food product to a desired viscosity in the mixer. The correct viscosity of the food product is necessary to ensure efficient subsequent processing of the food product when same is removed from the mixer. For example, if too much liquid cryogen is injected into the food product such will become frozen (due to the unnecessarily high viscosity), thereby creating inefficient removal of the food from the mixer and causing breakage of the forming dies used during subsequent processing of the product. If the liquid cryogen is injected into the food product in an amount insufficient to raise the viscosity to the desired level, the food product will remain a “soupy” mass, i.e. the food product will stick or cling to the interior of the mixer and to the forming dies used during the subsequent processing. Additionally, if the product viscosity is too low, it will be difficult if not impossible to immediately and subsequently process the product in for example dies or by forming or slicing after the product is removed from the mixer.

Such situations of inaccurate food product viscosities occur because the operator of the liquid cryogen injection into the mixer cannot determine with sufficient accuracy the necessary amount of liquid cryogen to be introduced into the mixer and therefore the food product, and cannot rely upon the sensor devices for accurate temperature measurement of the food product during the bottom injection of the cryogen. Neither situation is desirable due to the inefficient use of the liquid cryogen in the food product being processed.

It has been known to date to cure such deficiencies with the use of temperature sensors. However, such sensors are also problematic, in that same present particular problems such as discussed above. In general, during the cryogen injection stage or cycle, measuring liquid product temperature is however easier than similar measurements of solid food products such as for example beef, poultry or pork. This is due primarily to two different aspects of liquid and solid food products. First, liquid products generally do not require final temperatures below freezing for the subsequent processing or forming and therefore, relatively little ice is created which could adversely impact temperature sensing devices. This permits such devices to be used effectively in these applications. Second, the types of mixers used for the mixing process of solid products have “gaps” between the agitators and walls of such mixers. The gaps allow for accumulation and build-up of food product or frozen ice and therefore, prevent the sensing devices from contacting the solid food products to obtain accurate temperature measurements.

### SUMMARY OF THE PRESENT INVENTION

There is therefore provided herein accurate method embodiments to determine the correct amount of liquid cryogen to be introduced into a mixer for the food product therein so that same has the desired and correct viscosity when removed from the mixer for subsequent processing.

Certain embodiments include a method for adjusting a viscosity of a food product for processing in a mixer, including measuring a weight and introductory temperature of a batch of the food product; determining a viscosity of the batch of the food product necessary for subsequent processing; determining a processing temperature of the batch necessary to arrive at the viscosity; and introducing an amount of cryogen into the batch based upon enthalpy of the batch for arriving at the processing temperature.

Another embodiment includes a method, wherein the measuring of the weight and the introductory temperature of the batch includes using sensors for sensing the weight and the introductory temperature.

Still another embodiment includes a method, wherein the cryogen includes liquid cryogen.

Still another embodiment includes a method, wherein the cryogen is selected from the group consisting of liquid nitrogen and liquid carbon dioxide.

Still another embodiment includes a method, wherein the food product includes a protein food product.

Another method includes the protein food product being selected from the group consisting of poultry protein, beef protein and seafood protein.

The present embodiments (also referred to herein as the “embodiments”) remove discretion of the mixer operator from determining the amount of liquid cryogen to be introduced into the mixer to produce the food product with the desired viscosity.

The embodiments enable the operator to enter a desired final temperature of the food product based upon its particular enthalpy, whereupon the embodiments calculate an amount of the liquid cryogen needed to be bottom injected into the mixer.

The embodiments provide a product weight-based liquid cryogen delivery system that injects a precise amount of the liquid cryogen into the mixer to produce a food product having a select or desired viscosity for subsequent processing.

The present embodiments also provide a recordable cryogen delivery history for the operator to know the type and amount of liquid cryogen used with a particular weight and/or amount of a particular food product.

The embodiments can therefore during successive batch processing adjust the amount and type of liquid cryogen being delivered for different amounts and/or types of food product being chilled in the same mixer.

The present embodiments use product enthalpy combined with weight based injection to provide automatic, predictive cryogen delivery to the food product.

No known chilling system employs product enthalpy for determining an accurate amount of cryogen to be applied to the food product to produce same with a desired viscosity and consistency for subsequent processing.

With the present embodiments, the operator enters (i) the food product batch incoming temperature, (ii) the batch weight, and (iii) the desired final temperature. The system then calculates the amount of cryogen needed to achieve the desired viscosity of the product upon removal from the mixer.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a flow chart of the present method embodiment; and

FIG. 2 shows a table of the method embodiment for calculating an amount of cryogen to be added to the product to produce a desired viscosity for same.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

As used herein, liquid cryogen for the present embodiments means liquid nitrogen, carbon dioxide and liquid carbon dioxide.

As used herein, “enthalpy” is a property of a thermodynamic system. For example, the enthalpy of chicken protein is different from the enthalpy of beef protein. The enthalpy of a particular system, such as chicken or beef protein, is equal to the system's internal energy plus the product of its pressure and volume, i.e. the sum of the internal energy of a body and the product of its volume multiplied by the pressure or, in other words, enthalpy is a measure of heat load in BTU/lb. Each food product has its own specific enthalpic property or characteristic.

The present method embodiments use a product's enthalpy, such as the enthalpy of a food product, for predictive cryogen injection to the food product in combination with product weight to determine an amount of cryogen that must be introduced into the food product in the mixer so that the proper viscosity of the food product is realized upon removal of the product from the mixer for subsequent processing.

With the present embodiments, an operator of the mixer need only enter an initial temperature and weight of the food product in the mixer, and a desired final temperature for the food product upon removal from the mixer. The present embodiments calculate an amount of cryogen that must be introduced into the mixer for that particular batch of food product to achieve same at a desired final temperature for subsequent processing in for example dies or molds.

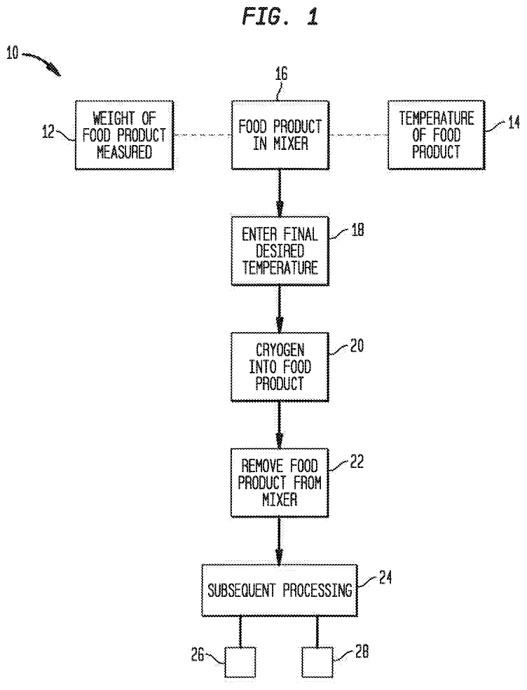

Referring to FIG. 1 and a process embodiment of the present invention shown generally at 10, an operator of the mixer enters the batch weight 12 and incoming temperature 14 of the food product batch type being introduced into the mixer 16. Alternatively, such entries can be done automatically with no operator involvement. This data entry “D” by the operator can occur by same introducing the food batch into the mixer, whereupon the gross weight of the mixer is measured less the weight of the mixer to arrive at a net weight of only the batch; while the temperature of the batch is measured in the mixer as well. Alternatively, the batch weight 12 can be automatically relayed or communicated from a mixer load cell which calculates the weight of the food product by subtracting the total or gross weight of the mixer with the product therein from the specific weight of the mixer, to arrive at the weight of the batch food product. Such automatic processing with respect to the initial temperature of the product can occur as well, in that such temperatures can be provided from the hoppers or vessels from which the meat products are provided or by non-contact type temperature sensing devices, such as for example infra-red (IR) probes before the food product is introduced into the mixer 16. However, IR probes would not necessarily be used during injection of the cryogen because the injected cryogen will block or obstruct the sensing path from the meat product to the IR probe in the vessel. Prior to the cryogen injection, there is no concern about such obstruction of the sensing path.

Another embodiment calls for the weight 12 and temperature 14 of the batch being measured and communicated to the operator before the batch is introduced into the mixer. In either situation, the operator need only enter the weight and temperature of the incoming batch; and then enter the final desired temperature 18 of the batch for removal from the mixer. If more than one type of food product will be processed, then the type of product must also be entered into the controller. Otherwise, a single recipe for the particular food product batch can be programmed into the controller without subsequent changing of the recipe. The final desired temperature 18 of the batch corresponds to a specific viscosity of the batch needed for subsequent processing in, for example, dies and molds.

The initial temperature of the food product can also be loaded into the system by the operator or alternatively, uploaded automatically by heat sensors.

The inputs 12,14,18 enable the system to calculate an amount of cryogen 20 to be introduced into the batch in the mixer in order to reduce the temperature of the product batch to bring about the required viscosity of the batch upon removal 22 from the mixer for subsequent processing 24. The product batch will therefore have the proper viscosity and consistency to be effectively and efficiently molded 26 or run through a die 28, for example.

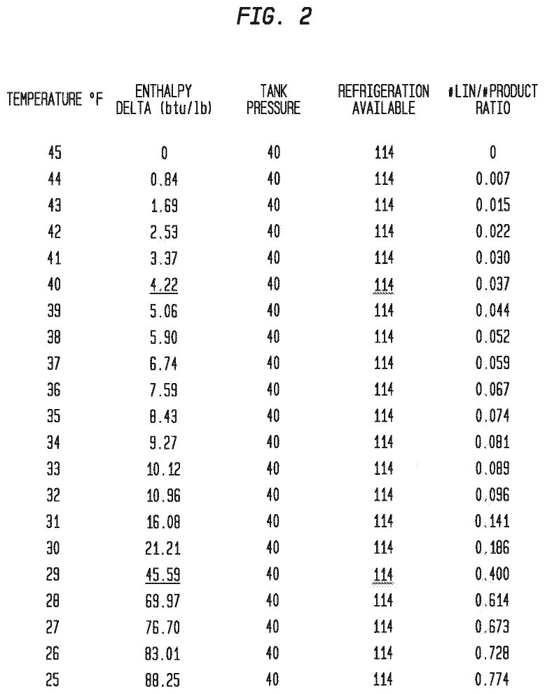

FIG. 2 shows examples of calculations that the present method embodiments use without the mixer operator having to estimate or determine how much cryogen to introduce into a particular batch of food product. Referring to the columns in FIG. 2:

Temperature-is the incoming temperature of the food product, such as for example a protein food product.
Enthalphy Delta-is specific to the type of food product, such as but not limited to a protein food product.
Tank Pressure-is that of the cryogen, such as for example LIN, in a storage tank or vessel for use with the method embodiments.
Refrigeration Available-the amount of cooling capacity of the LIN being used.
Different cryogens have different cooling capacities.
#LIN/#Product Ratio-is the Enthalpy or the refrigeration available.

### Example

Referring to FIG. 2, in order to determine an amount of the cryogen ratio with, for example liquid nitrogen (LIN), the following calculation is used:

(T2 enthalpy−T1 enthalpy)=Cryogen Ratio Refrigeration Available

### Wherein,

T2 is the enthalpy of the batch for removal from the mixer at the “select temperature” as described below, and T1 is the enthalpy of the batch at its temperature when first introduced into the mixer. Refrigeration Available is the cooling capacity of LIN, for this Example.

Accordingly, for this Example, an initial batch of a food product to be subsequently processed is at a batch weight of 3,000 lbs. (the “batch”). The batch is introduced at a temperature of 40° F. (T1) into a mixer. The batch will have to be reduced to a “select temperature” of 29° F. (T2) for discharge from the mixer. This select temperature T2 for the batch is necessary so that the batch will have a desired viscosity for subsequent processing during, for example forming, molding or injecting through a die, or possibly straight to packaging. In order to determine the Ratio and an amount of LIN to be introduced into the batch to bring about the select temperature, and still referring to FIG. 2, the difference or Delta (btu/lb.) of the batch enthalpy is:

Cryogen Ratio=(45.59−4.22)÷114=41.37÷114=0.363 #/#

To calculate an amount of the LIN to be introduced into the batch to reduce the temperature to 29° F., the above ratio is multiplied by the batch weight (3,000 lbs.).

### Therefore,

LIN needed=0.363×3,000 lbs.=1,089 lbs. of LIN needed to be introduced into the batch in the mixer to that the batch can be removed from the mixer at a temperature of 29° F. and have the necessary viscosity for the type of subsequent processing desired.

The present embodiments provide for: accuracy of the cryogen required; accuracy of a final desired product temperature; uniform repetition of processing variables for a particular food product; eliminating operator calculation error in the process of determining amount of cryogen to be added to a particular batch of food product; reducing overall cryogen consumption by eliminating operator excessively chilling the food product; and establishing a historical record of batch types, select temperatures and cryogen usage.

It will be understood that the embodiments described herein are merely exemplary, and that a person skilled in the art may make variations and modifications without departing from the spirit and scope of the invention. All such variations and modifications are intended to be included within the scope of the invention described and as provided in the appended claims. It should be understood that the embodiments described above are not only in the alternative, but can be combined.

What is claimed is:

1. A method for adjusting a viscosity of a food product for processing in a mixer, comprising:
measuring a weight and introductory temperature of a batch of the food product;
determining a viscosity of the batch of the food product necessary for subsequent processing;
determining a processing temperature of the batch necessary to arrive at the viscosity; and
introducing an amount of cryogen into the batch based upon enthalpy of the batch for arriving at the processing temperature.

2. The method of claim 1, wherein the measuring of the weight and the introductory temperature of the batch comprises using sensors for sensing the weight and the introductory temperature.

3. The method of claim 1, wherein the cryogen comprises liquid cryogen.

4. The method of claim 1, wherein the cryogen is selected from the group consisting of liquid nitrogen and liquid carbon dioxide.

5. The method of claim 4, wherein the amount of the liquid nitrogen introduced into the batch is determined by the calculation comprising:
$$\frac{( T 2 enthalpy - T 1 enthalpy )}{Refrigeration Available ,} = Cryogen Ratio$$
wherein,
T2 is the enthalpy of the batch for removal from the mixer at a select temperature;
T1 is the enthalpy of the batch at its temperature when first introduced into the mixer; and
Refrigerator Available is the cooling capacity of the liquid nitrogen.

6. The method of claim 1, wherein the food product comprises a protein food product.

7. The method of claim 6, wherein the protein food product is selected from the group consisting of poultry protein, beef protein and seafood protein.
